(19) United States
(12) Patent Application Publication
(10) Pub. No.: US 2006/0001849 A1
(43) Pub. Date: Jan. 5, 2006

(54) Imaging a violet sensitive printing plate using multiple low power light sources

(76) Inventors: Kevin B. Ray, Fort Collins, CO (US); Jianbing Huang, Trumbull, CT (US); Ken-ichi Shimazu, Briarcliff Manor, NY (US); Harald Baumann, Osterode (DE); Christopher D. McCullough, Fort Collins, CO (US)

Correspondence Address: Mark G. Bocchetti;Patent Legal Staff, Eastman Kodak Company, 343 State Street, Rochester, NY, 14650-2201, US

(21) Appl. No.: 11/167,338

(22) Filed: Jun. 27, 2005

Related U.S. Application Data
(60) Provisional application No. 60/584,549, filed on Jul. 1, 2004.

(51) Int. Cl. G03B 27/48

(52) U.S. Cl. 355/50

(57) ABSTRACT

Apparatus and method for exposing a lithographic printing plate wherein the apparatus includes a plurality of laser diodes emitting light of wavelength between 350 nm and 450 nm. The light from each of the laser diodes is directed onto the lithographic printing plate such that each spot on the lithographic printing plate receives light emitted from at least one of the laser diodes. Preferably, the lithographic printing plate is a violet-sensitive lithographic member and the lithographic member is a printing press plate. The power of each laser diode may be between 5 mW and 30 mW, and preferably the laser diodes emit light of wavelength between 390 nm and 430 nm.

### FIELD OF THE INVENTION

The present invention relates to laser printers in general, and in particular to imaging violet-sensitive lithographic members with violet laser diodes.

### BACKGROUND OF THE INVENTION

In the field of thermal printing, energy is transferred to dye donor materials from a laser through a plurality of optical fibers to generate an image with a plurality of simultaneously produced dots. See for example U.S. Pat. No. 5,168,288. High power lasers are also used to expose lithographic printing press plates.

There are several patents that the reader may wish to refer to for a general understanding of the background of the present invention. They include U.S. Pat. No. 5,385,092, No. 5,540,150, and No. 6,095,049 directed to imaging litho plates using laser devices that emit in the near-infrared. U.S. Pat. No. 6,222,870 discloses individually addressable laser crystals that are optically coupled to a single slab of an optical carrier that transmits without distortion. In U.S. Pat. No. 6,348,358, a linear array of diode laser emitters is manufactured with sufficient thermal and electronic isolation among the emitters to permit separate addressability.

Another patent of interest includes U.S. Pat. No. 6,210,864, directed to multi-mode laser radiation focused to a pre-selected spot size on a recording construction using a controlled angle diffuser. U.S. Pat. No. 5,517,359 teaches an apparatus for imaging the light from a laser diode on a multi-channel linear light valve.

A violet-sensitive photopolymerizable composition, which is developed in a conventional manner with aqueous alkaline solution in a separate apparatus, is disclosed in U.S. Pat. No. 6,335,144 and EP 1070990. EP 741333 discloses a photopolymerizable composition of a phosphinoxide photoinitiator in combination with a fluorescent optical brightener (oxazole or benzoxazole blocks are discussed). Commonly assigned U.S. Pat. No.3,912,606 discusses 2-halomethyl substituted benzoxazoles as radical photoinitiators. U.S. Pat. No. 3,647,467 describes a composition that can be photoactivated and includes a hexaarylbiimidazole derivative and a heterocyclic compound of the formula Ar1-G-Ar2, where Ar1 and Ar2 are aryl groups of 6 to 12 carbon atoms or an arylene-G-Ar1 group wherein arylene is of 6 to 10 carbon atoms and G is a divalent furan, oxazole or oxadiazole ring. The preferred compounds are oxadiazoles.

EP 129059 describes the synthesis and application of 2,4,5-triaryloxazoles as electrophotographic charge carrier generators. U.S. Pat. No. 5,204,222 describes photocurable elastomeric mixtures and recording materials for the production of relief printing plates. U.S. Pat. No. 5,800,965 discloses a composition comprising as the polymerizable component and poly(ethylene glycol) (PEG) monomers such as poly (ethylene glycol) mono acrylate or methacrylate. U.S. Pat. No. 6,258,512 describes a TiO₂ containing composition whose hydrophilicity is altered with exposure to light.

U.S. Pat. No. 6,466,359 describes a multi-beam exposure apparatus, including a light source for emitting a specified number of multi-beams spaced apart in a direction for auxiliary scanning, a deflecting unit and a main scanning unit. U.S. Pat. No. 4,796,961 discloses a multi-beam scanning optical system which comprises a plurality of laser beams with their polarization directions parallel to one another. U.S. Pat. No. 5,465,265 discusses a multi-beam laser light source constructed of a laser array in which a plurality of laser elements are arranged in an equi-interval, and a lens array in which a plurality of lenses employed in accordance with the plural laser elements are arranged in an equi-interval. U.S. Pat. No. 5,471,236 discusses a multi-beam scan optical system for writing image information. The system includes a laser array having a plurality of laser diodes, a collimate lens, and an optical member for focusing the collimated laser beams

Violet lasers that emit in the range of 350 nm to 450 nm are known. While such lasers are commercially available, the power of such lasers is presently limited to 5 mW to 150 mW, but the preferred range is only between 5 mW to 30 mW. On the other hand, violet-sensitive lithographic members, such as printing press plates, have sensitivities on the order of, say, 60 μJ/cm² to 100 μJ/cm².

It is commonly felt that printing press plates should be exposed at a rate of at least 20 plates per hour to be practical. At the laser powers that are presently commercially available, the plates would have to be very sensitive. For example, to expose a 2,919 cm² plate within 2 to 4 minutes, the plate would have to have a sensitivity of about 60 μJ/cm². Very sensitive violet-sensitive plates typically consist of a photosensitive photopolymer layer and an oxygen barrier layer. After being exposed to radiation of wavelength between 350 nm to 450 nm, such plates need to be heated to complete the chemical reaction in the photopolymer layer and then washed with water to remove the oxygen barrier layer. The unreacted materials in the photopolymer layer are removed in a separate step with an aqueous developer. Thus, the ultra sensitive violet-sensitive plates, after imaging-wise exposure to violet lasers, require complicated and costly processing steps before the plates are ready for use on printing presses.

It is an object of the present invention to provide apparatus and method for using commercially available, low power violet laser diodes to expose lithographic printing press plates within a practical amount of time without the need for ultra-sensitive plate chemistry.

### SUMMARY OF THE INVENTION

It is a feature of the present invention to provide apparatus for exposing a lithographic printing plate wherein the apparatus includes a plurality of laser diodes emitting light of wavelength between 350 nm and 450 nm; and the light from each of said laser diodes is directed onto the lithographic printing plate such that each spot on the lithographic printing plate receives light emitted from at least one of the laser diodes. Preferably, the lithographic printing plate is a violet-sensitive lithographic member. The power of each laser diode may be between 5 mW and 30 mW, and preferably the laser diodes emit light of wavelength between 390 nm and 430 nm.

It is another feature of the present invention to provide a method for exposing a lithographic printing plate by providing a plurality of laser diodes emitting light of wavelength between 350 nm and 450 nm; and directing light from each of said laser diodes onto the lithographic printing plate wherein each spot on the lithographic printing plate to be exposed receives light emitted from a plurality of the laser diodes.

### BRIEF DESCRIPTION OF THE DRAWINGS

FIG. 1 is a perspective view of a violet laser diode printer according to a feature of the present invention;

FIG. 2 is a perspective view of a fiber optic array suitable for use in the present invention;

FIG. 3 is a flow diagram of a plate exposure and development process according to the present invention; and

FIG. 4 is a flow diagram of a plate exposure and development process according to another embodiment of the present invention.

### DETAILED DESCRIPTION OF THE INVENTION

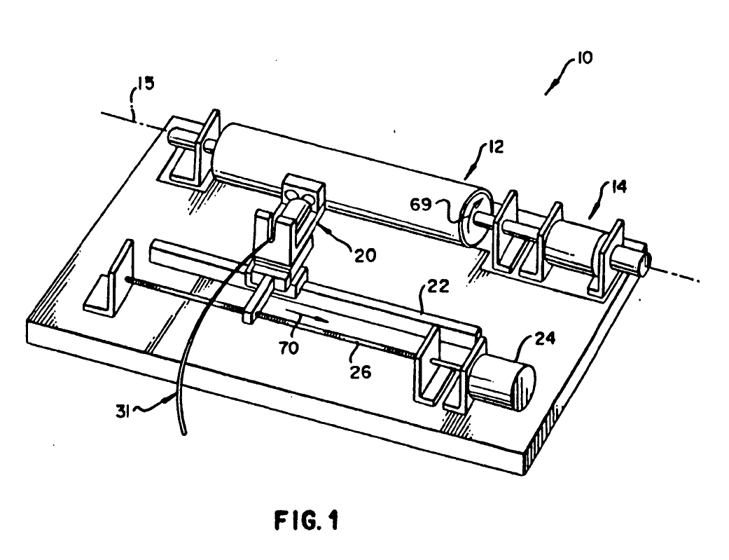

Referring to FIG. 1, a printer 10 comprises a drum 12 that is driven by a motor 14 for rotation about an axis 15. Drum 12 supports a printing plate, not shown. A print head 20 is slidably supported on a rail 22 such that a motor 24 that rotates a lead screw 26 drives the print head linearly along the rail.

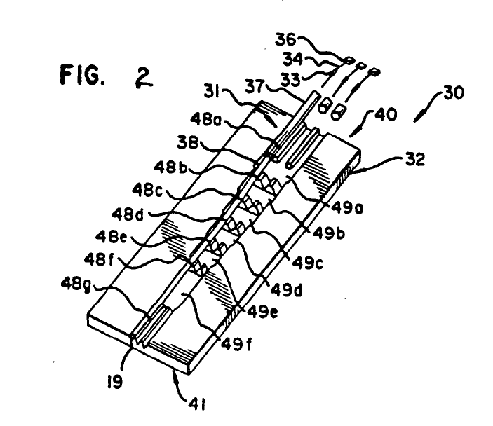

Referring to FIG. 2, print head 20 comprises an array 30. Array 30 comprises optical fibers 31 supported on a substrate 32. For clarity, the full length of only one of the optical fibers is shown in FIG. 2. It will be understood that the fibers are identical and extend the full length of substrate 32.

Each of the optical fibers is connected by means of an optical fiber connector 33 to another optical fiber 34, which is in turn connected individually to a violet laser 36. Violet lasers emit at 350 nm to 450 nm, and those that emit between 390 nm and 430 nm are preferred for use in accordance with the present invention. Each violet laser 36 can be individually modulated in accordance with an information signal input.

Each of the optical fibers 31 includes a jacket 37 and a cladding 38 about a central core. Jacket 37 has been removed from a portion of the fiber to expose the cladding 38. In an end portion 19, the diameter of the cladding can be substantially reduced so that the end portions 19 can be more closely spaced on substrate 32.

Fibers 31 extend from an input end 40 to an output end 41 of the array. The fibers are closest together at end 41, and are mounted in sets of grooves 48a-48g formed in substrate 32. Planar areas 49a-49f separate the grooves. Although only three fibers 31 are shown in FIG. 2, it will be understood that any number of fibers can be supported on substrate 32.

A lens, not shown, is adapted to focus the ends of optical fibers 31 onto the printing plate. In use, drum 12 is driven in the direction of arrow 69 by motor 14. Each of the fibers 31 in print head 20 are separately modulated in accordance with the information signal. Print head 20 is advanced continuously in the direction of arrow 70 so that a helical scan line is traced on the printing press. Alternatively, during a time when no information is being written, print head 20 can be stepped the distance of one swath for each revolution of drum 12 in order to trace concentric scan lines about the drum.

According to the present invention, multiple violet lasers 36 are used to image a violet sensitive plate. The phrase “multiple violet lasers” is intended to mean at least five and as many as fifty such lasers. Preferably, there would be about twenty-four to thirty-two or so violet lasers in a typical application of the present invention. Commercially available 5 mW, 12 mW, 30 mW, 40 mW and 150 mW violet lasers are presently found. Violet lasers of 5 mW or 30 mW power are preferred for use in the present invention.

In one preferred embodiment of the present invention, thirty-two 30 mW violet lasers 36 are aligned opposed to an eight-inch diameter drum 12 rotating at 300 rpm. The thirty-two combined lasers will deliver a total of 0.96 W of power at 405 nm. If the print head moves along the drum in increments of 338.67 microns per revolution and the plate area is 2919 cm², the plate would need a sensitivity of only 72 mJcm⁻² for full exposure within four minutes.

In another preferred embodiment of the present invention, twenty-four 5 mW InGaN violet lasers 36 are aligned opposed to an eight-inch diameter drum 12 rotating at 1,000 rpm. The thirty-two combined lasers will deliver a total of 120 mW of power. If the print head moves along the drum in increments of 254 microns per revolution and the plate area is 2919 cm², the plate would need a sensitivity of only 3 mJcm⁻² to complete the exposure within two minutes.

Thus, one can appreciate that the present invention allows the use of relatively low power lasers without the need for a very sensitive violet-sensitive plates (for example, plates of sensitivities of about 60 μJcm⁻²). Plates of that sensitivity typically require complicated processing steps after image-wise exposure As illustrated in FIG. 1, the preferred imaging configuration is an external drum. The output of each violet laser reaches the printing surface by means of a single print array. The apparatus comprises a plurality of violet laser sources. For an external drum configuration, an optical efficiency of 80% and a duty cycle close to 100% were assumed for the calculations set forth above. Were an internal drum or flat bed configuration used, the optical efficiencies would be much lower, typically 10% to 20% efficiency since the violet diode beams would have to be collimated. For an internal drum configuration, the duty cycle would be the fraction of the circumferential length of plate divided by the total drum circumference.

The violet sensitive plate preferably comprises a photopolymerizable composition applied to a lithographic support, with an optional overcoat having an oxygen barrier effect. The photopolymerizable composition preferably includes:
1. An ethylenically unsaturated free radical polymerizable compound;
2. A polymeric binder selected from the group consisting of at least I graft copolymer comprising a main chain polymer and poly(ethylene oxide) sidechains, a block copolymer having at least 1 poly(ethylene oxide) block and at least one non poly(ethylene oxide) block and combinations thereof;
3. A sensitizer compound of a 2,4,5-triaryloxazole derivative, or a heterocyclic compound of the formula Ar1-G-Ar2, where Ar1 and Ar2 are aryl groups of 6 to 12 carbon atoms or an arylene-G-Ar1 group wherein arylene is of 6 to 10 carbon atoms and G is a divalent furan, oxazole or oxadiazole ring; and
4. A co-initiator or combination of co-initiators.

The sensitizer is a 2,4,5-triaryloxazole derivative corresponding to Formula (I) wherein:

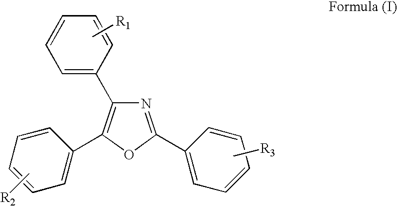

R₁, R₂ and R₃ each independently represent a hydrogen atom, alkyl, aryl or aralkyl group that may be substituted, an —NR₄R₅-group (R₄ and R₅ representing an alkyl, aryl or aralkyl group). —OR₆-group (R₆ representing an alkyl, aryl or aralkyl group. Preferred compounds of Formula (I) contain at least one of substituent R₁, R₂ and R₃ representing a donor group, preferably an amino group, most preferably a dialkylamino group. The synthesis of these compounds can be made following the procedure given in DE 1120875 and EP 129059.

The co initiator is selected from the group of
1) Metallocenes (preferred titanocene, mostly preferred bis (cyclopentadienyl)-bis-[2,6-difluoro-3-(pyrr-1-yl)-phenyl]titanium,
2) triazine derivatives having 1 to 3 CX₃-groups (X═Cl, Br, preferred Cl, examples are 2-phenyl-4,6-bis(trichloromethyl)-S-triazine, 2,4,6-tris(trichloromethyl)-S-triazine, 2-methyl-4,6-bis(trichloromethyl)-S-triazine, 2-(styryl-4,6-bis(trichloromethyl)-S-triazine, 2-(p-methoxystyryl)-4,6-bis(trichloromethyl)-S-triazine, 2-(4-methoxy-naphtho-1-yl)-4,6-bis-trichloromethyl-S-triazine, 2-(4-ethoxy-naphtho-1-yl)-4,6-bis-trichloromethyl-S-triazine, 2-[4-(2-ethoxyethyl)-naphtho-1-yl]-4,6-bis-trichloromethyl-S-triazine)
3) peroxides,
4) 2,4,5-triarylimidazolyl dimer,
5) onium salts (e.g. diazonium, sulfonium, iodonium, N-alkoxypyridinium salts),
6) oxime ethers or oxime esters,
7) N-phenyl glycine and derivatives of N-phenyl glycine,
8) anilinodiacetic acid and derivatives thereof, and
9) thiol compounds (e.g. mercaptobenzthiazole, mercaptobenzimidazole, mercaptotriazole).

The co-initiators can be used in combination with one or more other co-initiators. Preferred are 2,4,5-triarylimidazolyl dimer and a thiol compound. Mostly preferred are 2,2′-bis(o-chlorophenyl-4,4′,5,5′-tetraphenylbiimidazole and 2,2′-bis(o-chlorophenyl-4,4′,5,5′-tetra(m-methoxyphenyl)biimidazole in combination with a thiol compound.

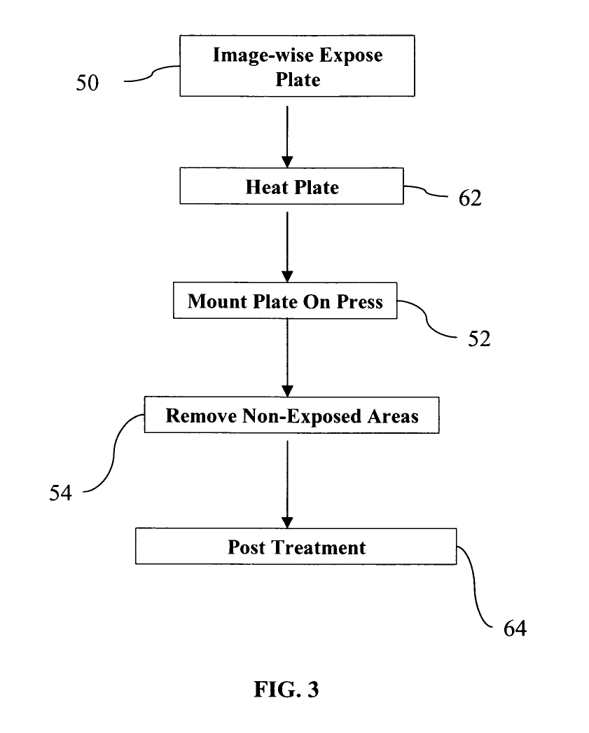

Referring to FIG. 3, the violet sensitive plate is image-wise exposed at step 50 by the multiple violet lasers. The plate is mounted on the printing press at step 52 and developed on press, step 54, without the need for a separate development step. During development, the non-exposed areas are removed by fountain solution and/or ink. It is noted that plates designed for on-press development can also be developed with a conventional process using a suitable aqueous developer.

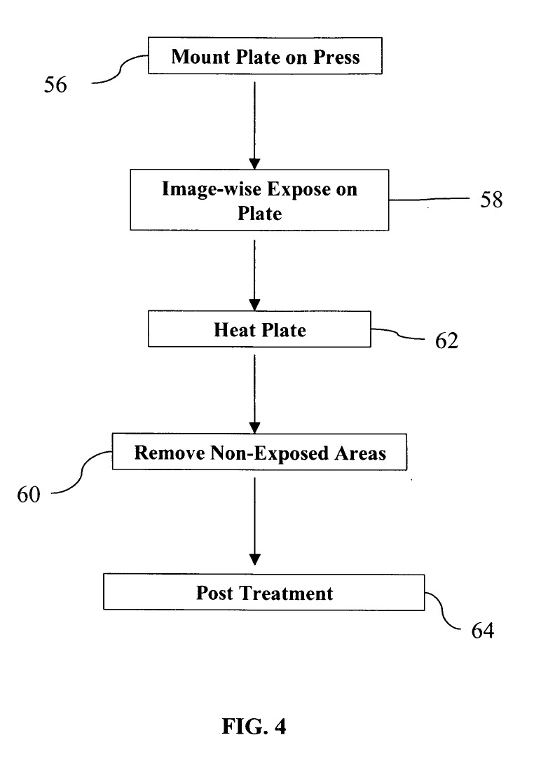

In the embodiment illustrated in FIG. 4, the violet sensitive plate is mounted on press, step 56 and image-wise exposed and subsequently developed on press, steps 58 and 60. The unexposed plate is simply mounted on press, wherein image wise exposure occurs, using the multiple violet lasers and next the non-exposed areas are removed by fountain solution and/or ink. In either of the embodiments of FIGS. 3 and 4, the plate may be subjected to an optional heating step 62 after exposure. Finally the plate may be optionally post-baked or subjected to a post UV-flood (on press) to increase press life, as illustrated at Step 64 of FIGS. 3 and 4.

In another preferred embodiment, a printing plate having a printing surface that includes a polymerizable composition is provided. The composition comprises an ethylenically unsaturated free radical polymerizable compound, a polymeric binder selected from the group consisting of at least 1 graft copolymer comprising a main chain polymer and poly(ethylene oxide) sidechains, a block copolymer having at least I poly(ethylene oxide) block and at least one non poly(ethylene oxide) block and combinations thereof, a sensitizer compound of a 2,4,5-triaryloxazole derivative or a heterocyclic compound of the formula Ar1-G-Ar2, where Ar1 and Ar2 are aryl groups of 6 to 12 carbon atoms or an arylene-G-Ar1 group wherein arylene is of 6 to 10 carbon atoms and G is a divalent furan, oxazole or oxadiazole ring, and a co-initiator or combination of co-initiators.

The plate is mounted onto a cylindrical drum spaced from at least one laser source or UV LED emitting at 350 nm to 450 nm, and more preferably emitting at 390 nm to 430 nm. The laser or LED source is imaged onto the printing surface of the plate to selectively expose the printing surface and cause the surface to become ink-accepting. Ink is applied to the plate and transferred to a recording medium.

Advantages:

Violet compositions having about 3 mJcm⁻² sensitivity can be exposed with inexpensive, multiple violet laser sources. Alternatively a 4-page plate with sensitivity of about 72 mJcm⁻² can be exposed with multiple violet laser sources within 4 minutes. The violet-sensitive materials could be photoresists for screen printing, printed circuit boards. Most preferred are lithographic printing plates. A method to image-wise expose and develop violet sensitive plates directly on press is described.

The use of multiple violet lasers negates the need for very fast (for example 60 μJcm⁻²) violet printing plates. There is no requirement to develop, or expose and develop, violet plates using separate exposing and developing apparatus.

### EXAMPLES

The following are referred to hereinafter:
BHT—2,6-di-tert-butyl-4-methylphenol, as supplied by Aldrich, Milwaukee, Wis.
Irganox 1035—benzenepropanoic acid, 3,5-bis(1,1-dimethylethyl)-4-hydroxythiodi-2,1-ethanediyl ester, as supplied by Ciba Geigy, Tarytown, N.Y.
Acryloid A11—methylmethacrylate polymer, as supplied by Rohm and Haas, Philadelphia, Pa.
Speedcure ITX—Isopropylthioxanthone as supplied by Lambson Chemicals, Castleford, UK
Triazine A—supplied by Panchim, Lisses, France.
Ebecryl 8301—urethane acrylate oligomer, as supplied by UCB, Louisville, Ky.
Sartomer SR399—Dipentaerythritol pentaacrylate, as supplied by Sartomer, Philadelphia, Pa.
Pluronic L43—polypropylene oxide polyethylene oxide block copolymer, as supplied by BASF, Mount Olive, N.J.
UR 3447—reaction product of DESMODUR N100 with hydroxyethyl acrylate and pentaerythritol triacrylate (urethane acrylate oligomer), as supplied by Bomar, Winsted, Conn.
WS-96—acrylic/methacrylic polymer, as supplied by Panchim.
Tolyl leuco violet—Bis(4-diethylamino-o-tolyl)(4-diethylamino phenyl) methane, as supplied by Hampford Research, Stratford, Conn.
Leuco crystal violet—as supplied by MERCK, Cincinatti, Ohio.
Byk 307—polyether modified dimethylpolysiloxane copolymer, as supplied by Byk Chemie, Wallingford, Conn.
Airvol 603—polyvinyl alcohol (80% hydrolysed), as supplied by Airproducts, Allerton, Pa.
KA-41—polyethylene-co-anhydride maleic/4 analin tempo amide, as supplied by Panchim.
Sodium gluconate—as supplied by Aldrich.
Sodium polyphosphate—as supplied by Aldrich.
Metanil yellow—as supplied by Aldrich.
Aerosol OT—sulfo-butanedioc acid, 1,4-bis(2-ethylhexyl) ester, as supplied by Cytec Industries, West Patterson, N.J.
Triton X100—nonylphenylpolyoxyethylene ether, as supplied by Rohm and Haas.
Zonyl FSN—telomer B monoether with polyethylene glycol, as supplied by DuPont, Wilmington, Del.
Triazine E—as supplied by Panchim.
Byk 336—a solution of a polyether modified dimethylpolysiloxane copolymer, as supplied by Byk Chemie.
VPOxa 1—a 2,4,5-triaryloxazole, having the following structure: 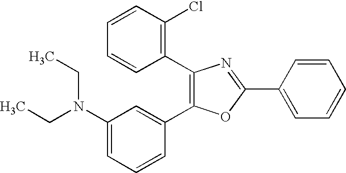
Mercapto-3-triazole—as supplied by Aldrich.
o-Cl-Habi—2,2-bis-(2-chlorophenyl)-4,5,4′,5′-tetraphenyl-2′H-[1,2′]biimidazole, as supplied by Charkit Chemicals Corporation, Darien, Conn.
Sartomer 355—a multifunctional acrylic monomer, as supplied by Sartomer Co., Inc.
Polyvinyl alcohol—Airvol 203 (hydrolysis level of 88%), as supplied by Airproducts.
Polyvinylimidazole—as supplied by Diversitec, Fort Collins, Colo.
Diphenyl iodonium chloride—as supplied by Aldrich.
4-phenyl-1-methoxypyridinium tetrafluoroborate—as supplied by Aldrich.

### Example 1

An electrochemically roughened (in hydrochloric acid) and sulfuric acid anodized aluminum sheet was subjected to an after treatment using an aqueous solution of polyvinyl phosphonic acid (PVPA) and coated with the following components (in 1-methoxypropan-2-ol, toluene, MEK, methoxypropylacetate; 58.9:25:15:1.1 (w:w)), using a wire wound bar. The formulation concentration is selected to provide a dry film having a coat weight of 1.25 gm⁻². The coating is dried at 90° C. for 75 seconds.

| Component | Parts by Weight |
|---|---|
| BHT | 0.15 |
| Irganox 1035 | 0.05 |
| Acryloid A11 | 11.97 |
| Speedcure ITX | 2.00 |
| Triazine A | 2.00 |
| Ebecryl 8301 | 3.59 |
| Sartomer SR399 | 24.94 |
| Pluronic L43 | 4.79 |
| UR 3447 | 28.93 |
| WS-96 | 18.07 |
| Tolyl leuco violet | 2.00 |
| Leuco crystal violet | 1.30 |
| Byk 307 | 0.21 |

The above coating is over-coated with the following components (in water, iso-propanol; 99.96:0.04 (w:w)), using a wire wound bar. The formulation concentration is selected to provide a dry film having a coat weight of 0.25 gm⁻². The coating is dried at 80° C. for 75 seconds.

| Component | Parts by Weight |
|---|---|
| Airvol 603 | 72.90 |
| KA-41 | 8.15 |
| Sodium gluconate | 4.17 |
| Sodium polyphosphate | 11.05 |
| Metanil yellow | 1.00 |
| Aerosol OT | 0.59 |
| Triton X100 | 1.00 |
| Zonyl FSN | 1.14 |

The sample is mounted on an 8-inch diameter external drum apparatus, equipped with a 32 channel violet laser head. The laser head is made of 32, NDHV310APB violet lasers (having 30 mW output power at 405 nm, at the recommended driving current, as supplied by Nichia Corporation of Shiba, Minato-Ku, Tokyo, Japan) and 32 optical fibers, (coupled with each laser on one end and packed into a linear array on the other). The violet light array from the optical fiber bundle is then projected via an optical lens to the external drum surface and thus forms 32 pixels, spaced 10.6 microns apart, which are linearly aligned along the drum axis. Each laser is driven by a power supply that provides a train of rectangular pulses with a floor current of 45 mA (the threshold current) and a ceiling current of 70 mA (the operating current). The drum rotates at 300 rpm and the laser head moves at an increment of 338.67 microns, along the drum axis after each rotation. The plate sample (having surface area: 2919 cm², dimensions 25 by 18 inches), takes about 4 minutes to complete the exposure. The sample is then trimmed to 13 by 20 inches and is mounted on an ABDick press and prints more than 500 copies of good quality prints.

### Example 2

A brush grained and phosphoric acid anodized aluminum sheet that was subjected to an after treatment using an aqueous solution of polyacrylic acid, is coated with the following components (in n-propanol, water, DEK; 60:20:20 (w:w)), using a wire wound bar. The formulation concentration is selected to provide a dry film having a coat weight of 0.75 gm⁻². The coating is dried at 70° C. for 75 seconds.

| Component | Parts by Weight |
|---|---|
| Graft copolymer 1 (from US2003/0064318) | 58.7 |
| Sartomer SR399 | 29.4 |
| Triazine E | 4.0 |
| Tolyl leuco violet | 4.5 |
| Leuco propyl violet | 0.5 |
| Byk 336 | 2.9 |

The sample is image-wise exposed as in example 1. The sample is then trimmed to 13 by 20 inches and is mounted directly on an ABDick press and prints more than 500 copies of good quality prints. The experiment is repeated, except that triazine E is replaced by triazine A.

### Example 3

### A Violet Sensitive Formulation is Exposed with Multiple Violet Lasers and is then Developed on Press

An electrochemically roughened (in hydrochloric acid) and anodized aluminum sheet that was subjected to an after treatment using an aqueous solution of polyvinyl phosphonic acid (PVPA), is coated with the following components (in n-propanol, water, DEK; 60:20:20 (w:w)), using a wire wound bar. The formulation concentration is selected to provide a dry film having a coat weight of 1.6 gm⁻². The coating is dried at 70° C. for 75 seconds.

| Component | Parts by Weight |
|---|---|
| Mercapto-3-triazole | 6.1 |
| o-Cl-Habi | 3.3 |
| VPOxa 1 | 14.0 |
| UR 3447 | 35.0 |
| Graft copolymer 1 (US2003/0064318) | 32.4 |
| Sartomer 355 | 9 |
| Byk 307 | 0.2 |

The sample is mounted on an external drum apparatus (8 inch diameter), equipped with a 24 channel violet laser head. The laser head is made of 24, 5 mW InGaN semiconductor violet lasers (having 5 mW output power at 400 nm, at the recommended driving current), and 24 optical fibers, (coupled with each laser on one end and packed into, a linear array on the other). The violet light array from the optical fiber bundle is then projected via an optical lens to the external drum surface and thus forms 24 pixels, which are linearly aligned along the drum axis. The drum rotates at 1000 rpm and the laser head moves at an increment of 254 microns, along the drum axis after each rotation. The plate sample (having surface area: 2919 cm², dimensions 25 by 18 inches), takes about 110 seconds to complete the exposure. The sample is then trimmed to 13 by 20 inches and is mounted directly on an ABDick press and prints more than 500 copies of good quality prints.

### Example 4

Example 3 is repeated except that the coating above is over-coated with a solution of polyvinyl alcohol (5.26 parts) and polyvinylimidazole (0.93 parts) in isopropanol (3.94 parts) and water (89.87 parts) to give a dry coat weight of 20 gm⁻². The coating is dried at 60° C. for 75 seconds.

The sample is image-wise exposed as in example 3 and is then trimmed to 13 by 20 inches and is mounted directly on an ABDick press where it prints more than 500 copies of good quality prints.

### Example 5

Example 3 is repeated except that graft copolymer 1 is replaced by graft copolymer 2 of US2003/0064318. The sample is image-wise exposed as in example 3. The plate sample takes about 2 minutes to complete the exposure. The sample is then mounted directly on a Komori press. The plate is then treated with Prisco liquid plate cleaner. The plate prints more than 27,000 copies of good quality reproductions.

### Example 6

Example 3 is repeated except that graft copolymer 1 is replaced by graft copolymer 3 of US2003/0064318. The sample is image-wise exposed as in example 3. The plate sample takes about 2 minutes to complete the exposure. The sample is then trimmed to 13 by 20 inches and is mounted directly on an ABDick press where it prints more than 1000 copies of good quality prints.

Another sample, prepared and imaged accordingly is mounted on a Komori press fitted with a hard blanket and using Equinox ink. The plate prints more than 40,000 copies of good quality prints.

### Example 7

Example 3 is repeated except that graft copolymer 1 is replaced by graft copolymer 5 of US2003/0064318. The sample is image-wise exposed as in example 3. The plate sample takes about 2 minutes to complete the exposure. The sample is then trimmed to 13 by 20 inches and is mounted directly on an ABDick press where it prints more than 400 copies of good quality prints.

### Example 8

Example 3 is repeated except that graft copolymer I is replaced by graft copolymer 1 (30.8% by weight) and graft copolymer 2 (1.6% by weight) of US2003/0064318. The sample is image-wise exposed as in example 3. The plate sample takes about 2 minutes to complete the exposure. The sample is then trimmed to 13 by 20 inches and is mounted directly on an ABDick press where it prints more than 1000 copies of good quality prints.

Another sample, prepared and imaged accordingly is mounted on a Komori press fitted with a hard blanket and using Equinox ink. The plate prints more than 30,000 copies of good quality prints.

### Example 9

Example 3 is repeated except that o-Cl-Habi is replaced with diphenyl iodonium chloride. The sample is image-wise exposed as in example 3. The plate sample takes about 2 minutes to complete the exposure. The sample is then trimmed to 13 by 20 inches and is mounted directly on an ABDick press where it prints more than 500 copies of good quality prints.

### Example 10

Example 3 is repeated except that o-Cl-Habi is replaced with 4-phenyl-1-methoxypyridinium tetrafluoroborate. The sample is image-wise exposed as in example 3. The plate sample takes about 2 minutes to complete the exposure. The sample is then trimmed to 13 by 20 inches and is mounted directly on an ABDick press where it prints more than 500 copies of good quality prints.

### Example 11

### A violet Sensitive Formulation is Exposed with Multiple Violet Lasers Directly on Press and is then Developed on Press

A sample of plate from example 3, having a surface area of 2919 cm², (dimensions 25 by 18 inches) is mounted to a plate cylinder (8 inch diameter) of a lithographic printing press. The press is equipped with a 24 channel violet laser head. The laser head is made of 24, 5 mW InGaN semiconductor violet lasers (having 5 mW output power at 400 nm, at the recommended driving current), and 24 optical fibers, (coupled with each laser on one end and packed into a linear array on the other). The violet light array from the optical fiber bundle is then projected via an optical lens to the external drum surface and thus forms 24 pixels, which are linearly aligned along the drum axis. The cylinder rotates at 1000 rpm and the laser head moves at an increment of 254 microns, along the drum axis after each rotation. The printing plate is selectively exposed in a pattern representing an image, which causes the surface of the plate to become ink-accepting. The exposing process takes about 2 minutes. After exposure, the surface of the plate is moistened with fountain solution and ink is applied. The non-exposed regions of the plate retain the fountain and repel the ink. The image-wise exposed regions of the plate accept the ink and repel the fountain. The ink is transferred to the surface of an intermediate blanket, which in turn transfers the ink to the surface of the material on which the image is to be reproduced. In this way, more than 500 copies of good quality prints are produced.

### Example 12

### A Printing Plate is Exposed with Multiple Violet Lasers Directly on Press and is then Developed on Press

A sample of plate from example I, having a surface area of 2919 cm², (dimensions 25 by 18 inches) is mounted to a plate cylinder (8 inch diameter) of a lithographic printing press. The press is equipped with a 32 channel violet laser head. The laser head is made of 32, NDHV310APB violet lasers—having 30 mW output power at 405 nm, at the recommended driving current (as supplied by Nichia Corporation of Shiba, Minato-Ku, Tokyo, Japan) and 32 optical fibers—coupled with each laser on one end and packed into a linear array on the other. The violet light array from the optical fiber bundle is then projected via an optical lens to the plate cylinder and thus forms 32 pixels, spaced 10.6 microns apart, which are linearly aligned along the cylinder axis. Each laser is driven by a power supply that provides a train of rectangular pulses with a floor current of 45 mA (the threshold current) and a ceiling current of 70 mA (the operating current). The cylinder rotates at 300 rpm and the laser head moves at an increment of 338.67 microns, along the cylinder axis after each rotation. The printing plate is selectively exposed in a pattern representing an image, which causes the surface of the plate to become ink-accepting. The exposing process takes about 4 minutes. After exposure, the surface of the plate is moistened with fountain solution and ink is applied. The non-exposed regions of the plate retain the fountain and repel the ink. The image-wise exposed regions of the plate accept the ink and repel the fountain. The ink is transferred to the surface of an intermediate blanket, which in turn transfers the ink to the surface of the material on which the image is to be reproduced.

### Example 13

### A Printing Plate is Exposed with Multiple Violet Lasers Directly on Press and is then Developed on Press

A sample of plate from example 2 (using triazine E), having surface area 2919 cm², (dimensions 25 by 18 inches) is mounted to the plate cylinder of the lithographic printing press described in example 13. The plate is exposed as in example 14, a process that takes about 4 minutes. After exposure, the surface of the plate is moistened with fountain solution and ink is applied. The non-exposed regions of the plate retain the fountain-and repel the ink. The image-wise exposed regions of the plate accept the ink and repel the fountain. The ink is transferred to the surface of an intermediate blanket, which in turn transfers the ink to the surface of the material on which the image is to be reproduced.

The invention has been described in detail with particular reference to certain preferred embodiments thereof, but it will be understood that variations and modifications can be effected within the spirit and scope of the invention.

### Parts List

10 Printer
12 Drum
14 Motor
15 Axis
19 End Portion
20 Printhead
22 Rail
24 Motor
26 Lead Screw
30 Array
31 Optical Fibers
32 Substrate
33 Optical Fiber Connector
34 Optical Fiber
36 Violet Laser
37 Jacket
38 Cladding
40 Input End
41 Output end
48a-48g Grooves
49a-49f Planar Areas
50 Step
52 Step
54 Step
56 Step
58 Step
60 Step
62 Step
64 Step
69 Arrow
70 Arrow

1. Apparatus for exposing a lithographic printing plate, said apparatus comprising:
a support for said lithographic printing plate, an imaging head comprising a plurality of laser diodes emitting light of wavelength between 350 nm and 450 nm and located in close proximity to the support;
a mechanical motion system for effecting relative motion of the imaging head and the support; and
an electronic control system for modulating the emission power of the laser diodes in synchronization with the mechanical motion system according to the data of a desired image.

2. Apparatus as set forth in claim 1 wherein said support is a rotary drum.

3. Apparatus as set forth in claim 2 wherein the said rotary drum is a plate cylinder of a digital printing press.

4. Apparatus as set forth in claim 1 further comprising a plurality of optical fibers, wherein each of the optical fibers has a first end coupled with a respective one of the laser diodes and a second end packed in close proximity to the second end of the other optical fibers to form an array of regularly spaced light spots.

5. Apparatus as set forth in claim 4 where the said imaging head further comprises an optical lens system for projecting light images from the optical fiber array onto the lithographic printing plate affixed to the said support.

6. Apparatus as set forth in claim 1 wherein each laser diode has a power of between 5 mW and 150 mW.

7. Apparatus as set forth in claim 6 wherein the power of each laser diode is between 5 mW and 30 mW.

8. Apparatus as set forth in claim 1 wherein the laser diodes emit light of wavelength between 390 nm and 430 nm.

9. Apparatus as set forth in claim 1 wherein said plurality of laser diodes include between 5 and 50 laser diodes.

10. Apparatus as set forth in claim 1 wherein the plate receives an energy dose of more than 1 mJcm⁻².

11. Apparatus as set forth in claim 1 wherein the plate receives a energy dose of more than 5 mJcm⁻².

12. Apparatus as set forth in claim 1 wherein the plate includes:
a hydrophilic substrate; and
an oleophilic photosensitive layer capable of hardening upon exposure to light of wavelength 350 nm to 450 nm, the non-hardened areas of said photosensitive layer being soluble or dispersible in at least one of ink and fountain solution.

13. Apparatus as set forth in claim 12 wherein the oleophilic photosensitive layer comprises:
an ethylenically unsaturated free radical polymerizable compound;
a polymeric binder selected from the group consisting of at least I graft copolymer comprising a main chain polymer and poly(ethylene oxide) sidechains, a block copolymer having at least I poly(ethylene oxide) block and at least one non poly(ethylene oxide) block and combinations thereof; and
a photoinitiator system.

14. Apparatus as set forth in claim 13 wherein the photoinitiator system comprises a 2,4,5-triaryloxazole derivative.

15. Apparatus as set forth in claim 12 wherein said plate includes an overcoat, which is soluble or dispersible in at least one of ink and fountain solution.

16. A method for exposing a lithographic printing plate, said method comprising:
providing a plurality of laser diodes emitting light of wavelength between 350 nm and 450 nm; and
directing light from each of said laser diodes onto the printing plate wherein each spot on the printing plate to be exposed receives light emitted from at least one of the plurality of the laser diodes.

17. The method as set forth in claim 16 wherein the said laser diodes each emit a power between 5 mW and 150 mW.

18. The method as set forth in claim 17 wherein the step of providing a plurality of laser diodes includes providing each laser diode with a power between 5 mW and 30 mW.

19. The method as set forth in claim 16 wherein the step of providing a plurality of laser diodes includes providing laser diodes that emit light of wavelength between 390 nm and 430 nm.

20. The method as set forth in claim 16 wherein the step of providing a plurality of laser diodes includes providing between 5 and 50 laser diodes.

21. The method as set forth in claim 16 wherein the printing plate includes:
a hydrophilic substrate; and
an oleophilic photosensitive layer capable of hardening upon exposure to light of wavelength 350 nm to 450 nm, the non-hardened areas of said photosensitive layer being soluble or dispersible in at least one of ink and fountain solution.

22. The method as set forth in claim 21 wherein the oleophilic photosensitive layer comprises:
an ethylenically unsaturated free radical polymerizable compound;
a polymeric binder selected from the group consisting of at least I graft copolymer comprising a main chain polymer and poly(ethylene oxide) sidechains, a block copolymer having at least 1 poly(ethylene oxide) block and at least one non poly(ethylene oxide) block and combinations thereof, and a photoinitiator

23. The method as set forth in claim 22 wherein the photoinitiator is 2,4,5-triaryloxazole derivative.

24. The method as set forth in claim 21 wherein said printing plate includes an overcoat that is soluble or dispersible in at least one of ink and fountain solution.
